(19) United States
(12) Patent Application Publication
(10) Pub. No.: US 2010/0285389 A1
(43) Pub. Date: Nov. 11, 2010

(54) FUEL CELL

(76) Inventors: Akira Yajima, Tokyo (JP); Yoshie Ozeki, Saitama-ken (JP); Nobuyasu Negishi, Kanagawa-ken (JP); Koichi Kawamura, Kanagawa-ken (JP); Takashi Shimoyamada, Kanagawa-ken (JP); Motoi Goto, Kanagawa-ken (JP); Kenichi Takahashi, Kanagawa-ken (JP); Naoki Iwamura, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/679,004

(22) PCT Filed: Sep. 24, 2008
(86) PCT No.: PCT/JP2008/002635

§ 371 Date: Jul. 12, 2010

(30) Foreign Application Priority Data
Sep. 27, 2007 (JP) 2007-251654
Jun. 4, 2008 (JP) 2008-147076

(51) Int. Cl. H01M 8/10

(52) U.S. Cl. 429/483

(57) ABSTRACT

The present invention relates to a fuel cell including a plurality of unit membrane electrode assemblies having an electrolyte membrane sandwiched by fuel electrodes and air electrodes. In recent years, attempts have been made to use fuel cells as power sources of portable electronic devices, and if the fuel cell can be made compact, it becomes a remarkably advantageous power supply system for portable electronic devices. Generally, in the fuel cell, the plural unit membrane electrode assemblies are electrically connected in series, but the serial connection of the unit membrane electrode assemblies different in output has a problem such as the deterioration due to polarity reversal occurring in the unit membrane electrode assembly with a low output. The present invention solves the above problem by the structure in which the fuel cell includes: the membrane electrode assembly group in which the plural unit membrane electrode assemblies are arranged two-dimensionally so as to be a predetermined interval apart from each other in a circumferential direction around a given center point, with the same electrodes being set on the same side; and a fuel supply mechanism disposed on the fuel electrode side of the membrane electrode assembly group and supplying a fuel to the fuel electrodes.

### TECHNICAL FIELD

The present invention relates to a fuel cell using a liquid fuel.

### BACKGROUND ART

In recent years, in order to enable long-hour use of various kinds of portable electronic devices such as laptop personal computers and portable phones without charging, attempts have been made to use fuel cells as power sources of these portable electronic devices. The fuel cell has a feature that it is capable of generating electricity only by being supplied with a fuel and air and is capable of continuously generating electricity for long hours by being replenished with the fuel. Therefore, the fuel cell can be an extremely advantageous system as a power source of portable electronic devices if it can be made compact.

A direct methanol fuel cell (DMFC) is expected to be a promising power source of portable electronic devices because it can be made compact and its fuel can be handled easily. As a method of supplying a liquid fuel in the DMFC, there have been known an active method such as a gas supply type and a liquid supply type, and a passive method such as an internal vaporization type in which a liquid fuel in a fuel storage part is vaporized inside the cell and the vaporized liquid fuel is supplied to a fuel electrode. For example, JP-B2 3413111 describes a fuel cell using a passive method such as an internal vaporization type.

Among them, the passive method such as the internal vaporization type is especially advantageous in terms of the miniaturization of the DMFC. For example, WO 2005/112172 A1 proposes a passive-type DMFC which is structured such that a membrane electrode assembly (fuel cell unit) having an anode (fuel electrode), an electrolyte membrane, and a cathode (air electrode) is disposed on a fuel storage part which is a box-shaped container made of resin. In the direct supply of a fuel vaporized from the fuel storage part to the fuel cell unit, it is important to enhance controllability of an output of the fuel cell, but sufficient controllability has not necessarily been obtained in the current passive-type DMFC.

Meanwhile, for example, in JP-A 2005-518646 (KOHYO), JP-A 2006-085952 (KOKAI), and US 2006/0029851 A1, connecting a fuel cell unit and a fuel storage part via a channel in a DMFC is considered. Since a liquid fuel supplied from the fuel storage part is supplied to the fuel cell unit via the channel, it is possible to adjust a supply amount of the liquid fuel based on the shape, diameter, and the like of the channel. For example, JP-A 2006-085952 (KOKAI) describes a fuel cell using a pump for supplying a liquid fuel from a fuel storage part to a channel. Further, US 2006/0029851 A1, for example, describes a fuel cell using an electroosmotic flow pump for supplying a liquid fuel or the like.

Further, in a fuel cell in which the above-described membrane electrode assemblies are disposed two-dimensionally, an edge portion of the membrane electrode assembly radiates a large amount of heat to the surrounding atmosphere or the like and thus has a low temperature, which sometimes prevents the promotion of a chemical reaction in an anode catalyst layer and a cathode catalyst layer in this edge portion. Further, in the fuel cell of the internal vaporization type in which a gaseous fuel is generated by the vaporization of a fuel inside the fuel cell, heat generated in the membrane electrode assembly is often used as a heat source causing the vaporization of the fuel. In this case, in the edge portion, due to the low temperature of the membrane electrode assembly itself, it is not sometimes possible to obtain a heat quantity large enough to vaporize the fuel. In the edge portion of the membrane electrode assembly not having a heat quantity large enough to vaporize the fuel, an amount of the supplied gaseous fuel becomes small and the output sometimes further lowers. On the contrary, in a center portion of the membrane electrode assembly, the temperature becomes high because heat is not easily radiated therefrom to the surrounding atmosphere or the like, so that an amount of the supplied gaseous fuel increases and the output tends to become high.

Further, with an aim to improve thermal cycle resistance of a fuel cell, JP-A 2004-235060 (KOKAI), for example, proposes a ring-shaped membrane electrode assembly having a center through hole and a plurality of surrounding through holes by which the distribution of heat and stress generated inside the membrane electrode assembly can be made uniform. This document describes a fuel cell in which a temperature difference inside the membrane electrode assembly is reduced by the center hole and the plural surrounding through holes disposed around the center hole, thereby reducing a heat stress generated in the whole membrane electrode assembly.

In a membrane electrode assembly group composed of a plurality of unit membrane electrode assemblies, the unit membrane electrode assemblies are generally connected in series. Therefore, currents flowing in the respective unit membrane electrode assemblies are equal to one another. Here, JP-A 6-52881 (KOKAI), for example, discloses an art in which, in a solid electrolyte fuel cell, unit cells in a unit cell group are arranged so that adjacent unit cells are different in polarity, and for electric connection between the unit cell groups vertically stacked, an upper end and a lower end of the unit cell groups adjacently stacked are connected.

Further, in the above-described membrane electrode assembly group, when the unit membrane electrode assemblies having different outputs are connected in series, the high-output unit membrane electrode assembly has a high voltage and the low-output unit membrane electrode assembly has a low voltage. It is known that, when so-called “polarity reversal” occurs, that is, when the voltage of the unit membrane electrode assembly becomes low to be “0” or less, especially a catalyst included in an anode catalyst layer, a carbon material carrying the catalyst, or the like makes an electrochemically abnormal reaction in this unit membrane electrode assembly to deteriorate. A possible solution to prevent the deterioration may be to reduce a current value to such an extent to eliminate a possibility of the occurrence of the polarity reversal in all the unit membrane electrode assemblies, but this results in a small output obtained in the whole fuel cell.

Further, when various members forming the fuel cell are stacked and fixed, it is easy to firmly fix their edge portions by screws, bolts, caulking, welding, or the like, and consequently, it is possible to reduce contact resistance between the membrane electrode assembly group and anode and cathode conductive layers and reduce other resistance components. On the other hand, in center portions, the same fixing as that of the edge portions is difficult, and contact resistance and other resistance components tend to be larger than those of the edge portions.

In the conventional membrane electrode assembly, it depends which of the unevenness in temperature and fuel supply amount and the unevenness in contact resistance and so on described above has a main influence on an output characteristic and so on of the fuel cell, because the output characteristic and so on change not only depending on the structure of the membrane electrode assembly but also depending on the structure of the whole fuel cell, and moreover, depending on the environment (temperature of the atmosphere and the like) where it is used, and so on.

For example, when the membrane electrode assembly group is sandwiched from above and under by members that are firm and do not bend much, the aforesaid unevenness in contact resistance is almost negligible. However, this structure is not suitable as a power source of a portable device since the whole fuel cell has too large a weight and volume.

Further, in the application of a fuel cell as a power source of a portable device, when the surrounding air temperature is high and a temperature difference between the air temperature and the membrane electrode assembly is small, the unevenness in temperature has a small influence on the output characteristic and so on of the fuel cell, but when the surrounding air temperature is low and a temperature difference between the air temperature and the membrane electrode assembly group of the fuel cell is large, the unevenness in temperature has a great influence on the output characteristic and so on of the fuel cell and a stable output cannot be sometimes obtained.

Patent Reference 1: JP-B2 3412111

Patent Reference 2: WO 2005/112172 A1

Patent Reference 3: JP-A 2005-518646 (KOHYO)

Patent Reference 4: JP-A 2006-085952 (KOKAI)

Patent Reference 5: US 2006/0029851 A1

Patent Reference 6: JP-A 2004-235060 (KOKAI)

Patent Reference 7: JP-A 6-52881 (KOKAI)

### DISCLOSURE OF THE INVENTION

Under such circumstances, it is an object of the present invention to provide a fuel cell capable of stably maintaining a high output by equalizing outputs of unit membrane electrode assemblies.

According to an aspect of the present invention, there is provided a fuel cell including: a membrane electrode assembly group in which a plurality of unit membrane electrode assemblies having fuel electrodes, air electrodes, and an electrolyte membrane sandwiched by the fuel electrodes and the air electrodes are arranged two-dimensionally so as to be a predetermined interval apart from each other in a circumferential direction around a given center point, with the same electrodes being set on a same side; and a fuel supply mechanism disposed on the fuel electrode side of the membrane electrode assembly group and supplying a fuel to the fuel electrodes.

### BRIEF DESCRIPTION OF DRAWINGS

FIG. 1 is a cross-sectional view showing the structure of a fuel cell of an embodiment according to the present invention.

FIG. 2 is a plane view when a membrane electrode assembly group in the fuel cell of the embodiment according to the present invention is seen from above the fuel cell shown in FIG. 1.

FIG. 3 is a plane view when a membrane electrode assembly group with another structure in the fuel cell of the embodiment according to the present invention is seen from above the fuel cell in FIG. 1.

FIG. 4 is a chart showing a correlation between a value (current density) of a current flowing per 1 cm² area of each unit membrane electrode assembly and a voltage generated in the unit membrane electrode assembly at this time.

FIG. 5 is a cross-sectional view showing the structure when the fuel cell of the embodiment according to the present invention includes a pump.

FIG. 6A is a developed view of a conductive layer-forming sheet for forming anode conductive layers and cathode conductive layers.

FIG. 6B is an explanatory view showing a process of forming the anode conductive layers and the cathode conductive layers from the conductive layer-forming sheet shown in FIG. 6A.

FIG. 7A is a developed view of a conductive layer-forming sheet in another form for forming the anode conductive layers and the cathode conductive layers.

FIG. 7B is an explanatory view showing a process of forming the anode conductive layers and the cathode conductive layers from the conductive layer-forming sheet shown in FIG. 7A.

FIG. 8 is an explanatory view showing a process of forming the anode conductive layers and the cathode conductive layers from conductive layer-forming sheets in still another form for forming the anode conductive layers and the cathode conductive layers.

FIG. 9A is a plane view when a fuel cell according to the present invention is seen from an air electrode side.

FIG. 9B is a plane view showing a side surface of the fuel cell according to the present invention.

FIG. 10 is a partial cross-sectional view showing the rough structure of the fuel cell according to the present invention.

FIG. 11 is an exploded perspective view showing the fuel cell according to the present invention disassembled into constituent elements.

FIG. 12 is an exploded perspective view showing a membrane electrode assembly/current collector assembly further disassembled into constituent elements.

FIG. 13 is a plane view showing a hexagonal membrane electrode assembly/current collector assembly having six membrane electrode assembly segments.

FIG. 14 is a perspective view showing an essential part of a sealing member disposed between the adjacent membrane electrode assembly segments.

FIG. 15 is a cross-sectional view showing the essential part of the sealing member disposed between the adjacent membrane electrode assembly segments.

FIG. 16 is a chart showing the measurement results of voltages of the unit membrane electrode assemblies in accordance with the control of a current.

FIG. 17 is a cross-sectional view showing the structure of a fuel cell used in a comparative example 1.

FIG. 18 is a plane view when a membrane electrode assembly group in the fuel cell used in the comparative example 1 is seen from above the fuel cell shown in FIG. 10.

### EXPLANATION OF NUMERALS AND SYMBOLS

1 . . . fuel cell, 5 . . . membrane electrode assembly group, 10 . . . unit membrane electrode assembly, 11 . . . anode catalyst layer, 12 . . . anode gas diffusion layer, 13 . . . anode (fuel electrode), 14 . . . cathode catalyst layer, 15 . . . cathode gas diffusion layer, 16 . . . cathode (air electrode), 17 . . . electrolyte membrane, 18 . . . anode conductive layer, 19 . . . cathode conductive layer, 20 . . . O-ring, 30 . . . fuel distribution layer, 31 . . . opening, 40 . . . fuel supply mechanism, 41 . . . fuel storage part, 42 . . . fuel supply part main body, 43 . . . fuel supply part, 44 . . . channel, 50 . . . moisture retention layer, 60 . . . surface cover, 61 . . . air inlet port, F . . . liquid fuel

### BEST MODE FOR CARRYING OUT THE INVENTION

Hereinafter, embodiments of the present invention will be described with reference to the drawings.

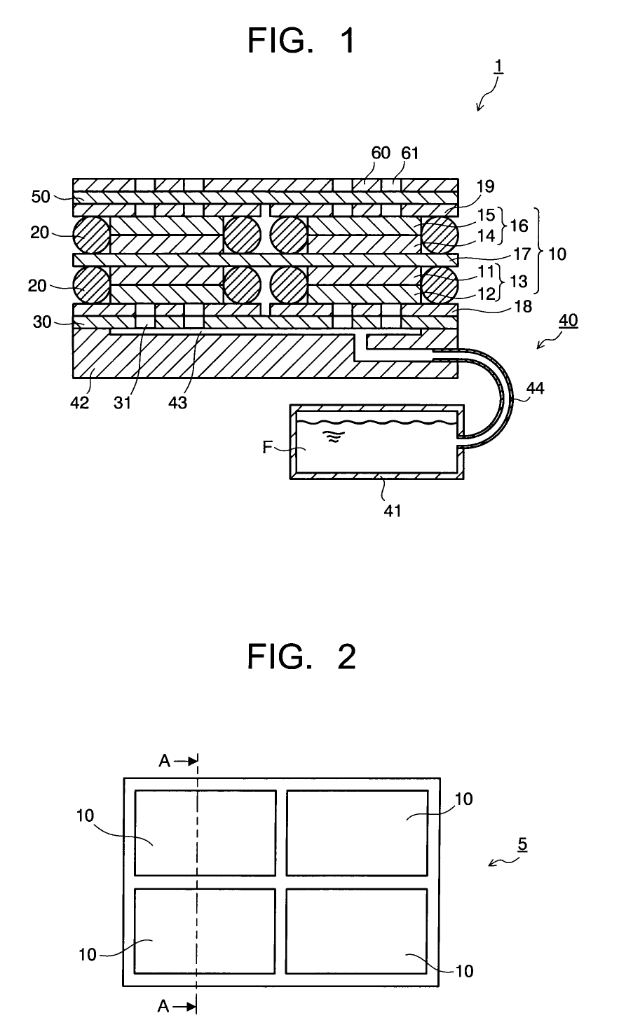

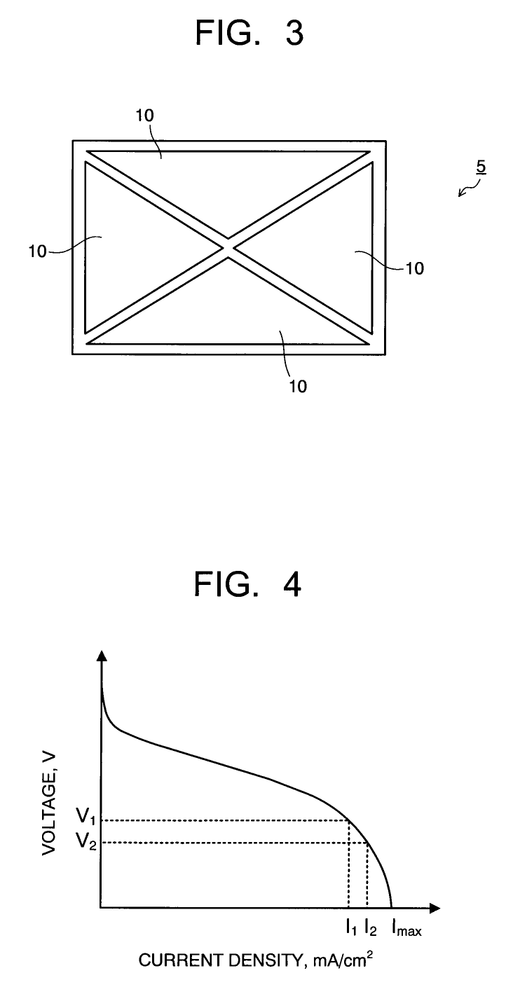

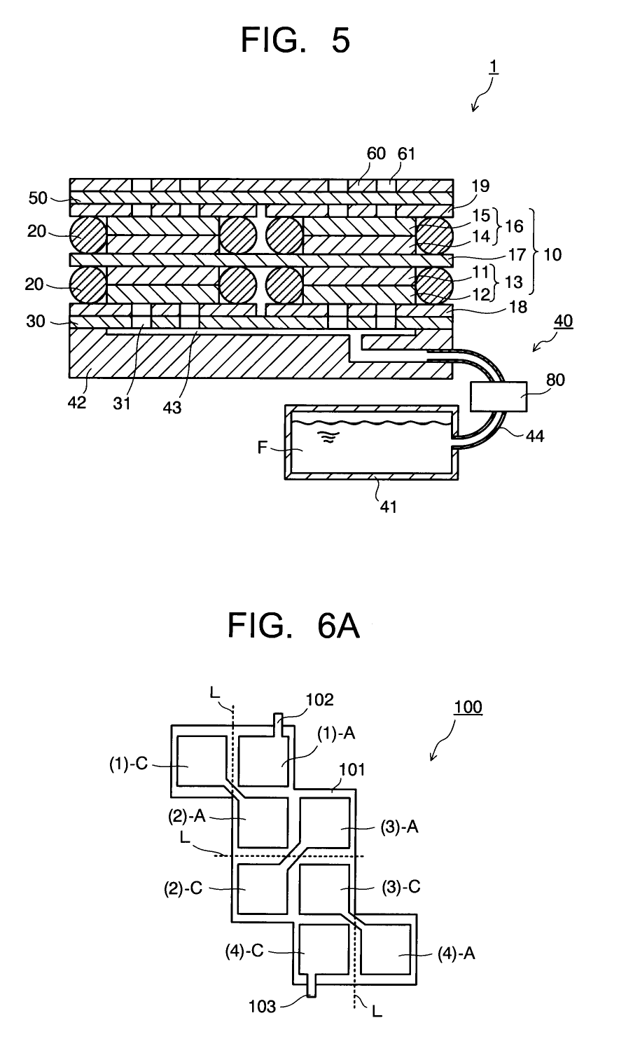

FIG. 1 is a cross-sectional view showing the structure of a fuel cell 1 of an embodiment according to the present invention. FIG. 2 is a plane view when a membrane electrode assembly group 5 in the fuel cell 1 of the embodiment according to the present invention is seen from above the fuel cell 1 shown in FIG. 1. FIG. 3 is a plane view when a membrane electrode assembly group 5 with a different structure in the fuel cell 1 of the embodiment according to the present invention is seen from above the fuel cell 1 shown in FIG. 1. FIG. 4 is a chart showing a correlation between a value (current density) of a current flowing in each unit membrane electrode assembly 10 per 1 cm² area and a voltage generated in the unit membrane electrode assembly 10 at this time. FIG. 5 is a cross-sectional view showing the structure when the fuel cell 1 of the embodiment according to the present invention includes a pump 80.

As shown in FIG. 1, the fuel cell 1 includes the membrane electrode assembly group 5 having the plural membrane electrode assemblies (MEA) (hereinafter, referred to as unit membrane electrode assemblies 10) each being a stand-alone body forming an electromotive part, and on an anode (fuel electrode) side and a cathode (air electrode) side of each of the unit membrane electrode assemblies 10, an anode conductive layer 18 and a cathode conductive layer 19 are provided respectively. The fuel cell 1 further includes: a fuel distribution layer 30 provided to face the anode conductive layers 18 and having a plurality of openings 31; a fuel supply mechanism 40 disposed opposite the unit membrane electrode assemblies 10 across the fuel distribution layer 30 to supply a liquid fuel F to the fuel distribution layer 30; a moisture retention layer 50 stacked on the cathode conductive layers 19; and a surface cover 60 stacked on the moisture retention layer 50 and having a plurality of air inlet ports 61. The cross section of the fuel cell 1 shown in FIG. 1 is an A-A cross section of FIG. 2, that is, shows the structure of the fuel cell 1 corresponding to the two unit membrane electrode assemblies 10, and the structure of the fuel cell 1 corresponding to the other unit membrane electrode assemblies not shown in FIG. 1 is also the same.

The unit membrane electrode assemblies 10 are composed of anodes (fuel electrodes) 13 each having an anode catalyst layer 11 and an anode gas diffusion layer 12, cathodes (air electrodes) 16 each having a cathode catalyst layer 14 and a cathode gas diffusion layer 15, and an electrolyte membrane 17 sandwiched by the anode catalyst layers 11 and the cathode catalyst layers 14 and having proton (hydrogen ion) conductivity.

As shown in FIG. 2, in the membrane electrode assembly group 5, the plural unit membrane electrode assemblies 10 are uniformly arranged two-dimensionally so as to be predetermined intervals apart from one another in a circumferential direction around a given center point, with the same electrodes being set on the same side. As an example of the structure, FIG. 2 shows a structure in which the four rectangular unit membrane electrode assemblies 10 are arranged in matrix at predetermined intervals around a given center point. That is, the four unit membrane electrode assemblies 10 are arranged and structured so that the unit membrane electrode assemblies 10 are equal in ratio between a portion located in a center portion of the fuel cell 1 and a portion located in its edge portion. In order to electrically connect the unit membrane electrode assemblies 10 in series, the anode conductive layers 18 and the cathode conductive layers 19 corresponding to the unit membrane electrode assemblies 10 are electrically connected. Further, the predetermined intervals between the unit membrane electrode assemblies 10, that is, gaps formed between the unit membrane electrode assemblies 10 are provided to electrically insulate the unit membrane electrode assemblies 10 from one another.

Further, areas of surfaces of the unit membrane electrode assemblies 10, that is, areas of the electromotive parts are preferably equal to one another. Normally, in the fuel cell 1, the center portion has a high temperature and the edge portion has a low temperature. With the above-described arrangement and structure of the unit membrane electrode assemblies 10, the unit membrane electrode assemblies 10 have the same temperature distribution state, that is, the same uneven temperature distribution state, so that substantially the same output characteristic is obtained in the unit membrane electrode assemblies 10. This can prevent the aforesaid occurrence of the polarity reversal which is caused by the uneven outputs of the unit membrane electrode assemblies 10 when the unit membrane electrode assemblies 10 are electrically connected in series.

Further, the arrangement and structure of the unit membrane electrode assemblies 10 are not limited to the arrangement and structure shown in FIG. 2, and for example, the membrane electrode assembly group 5 may be formed in a rectangular shape, with the unit membrane electrode assemblies 10 having a triangular shape each and being uniformly arranged two-dimensionally around a given center point at predetermined intervals. Alternatively, the membrane electrode assembly group 5 may be formed in a polygonal shape, with the unit membrane electrode assemblies 10 having a triangular shape each and being uniformly arranged two-dimensionally around a given center point at predetermined intervals. Alternatively, the membrane electrode assembly group 5 may be formed in a circular shape, with the unit membrane electrode assemblies 10 having a fan shape each and being uniformly arranged two-dimensionally around a given center point at predetermined intervals.

Here, a more concrete description will be given with reference to the example shown in FIG. 3 where the membrane electrode assembly group 5 is formed in a rectangular shape, with the unit membrane electrode assemblies 10 having a triangular shape each and being uniformly arranged two-dimensionally around a given center point.

In this case, it is also preferable that the areas of the surfaces of the unit membrane electrode assemblies 10, that is, the areas of the electromotive parts are equal to one another. Furthermore, when different triangular shapes are included as shown in FIG. 3, it is preferable not only that the areas of the surfaces of the unit membrane electrode assemblies 10 are equal to one another but also that consideration is given to the shapes so that the unit membrane electrode assemblies 10 are substantially equal in ratio of a high-temperature region and a low-temperature region. Here, the high-temperature region and the low-temperature region may be distinguished in such a manner that, for example, an average value of the temperatures of the surfaces of the unit membrane electrode assemblies 10 is set as a boundary value, and a region having a higher temperature than the boundary value is considered as the high-temperature region and a region having a temperature equal to or lower than the boundary value is considered as the low-temperature region. The distinction between the high-temperature region and the low-temperature region is not limited to this, and can be appropriately changed according to a form and a characteristic of the fuel cell 1.

When the areas of the four triangles cannot be made equal to one another, the unit membrane electrode assemblies 10 are preferably structured so that the area of the surface of the unit membrane electrode assembly 10 whose surface area is the smallest (hereinafter, referred to as the unit membrane electrode assembly 10 with the smallest area) is 90% or more of the surface area of the unit membrane electrode 10 whose surface area is the largest (hereinafter, referred to as the unit membrane electrode assembly 10 with the largest area). Here, the reason why the unit membrane electrode assemblies 10 are preferably structured so that the surface area of the unit membrane electrode assembly 10 with the smallest area is 90% or more of the surface area of the unit membrane electrode assembly 10 with the largest area will be described with reference to FIG. 4.

Here, in FIG. 4, I₁ is current density in the unit membrane electrode assembly 10 with the largest area among the unit membrane electrode assemblies 10 and V₁ is a voltage generated in this unit membrane electrode assembly 10, and similarly, I₂ is current density in the unit membrane electrode assembly 10 with the smallest area and V₂ is a voltage generated in this unit membrane electrode assembly 10. Further, Iₘₐₓ is a value (hereinafter, referred to as limit current density) of the current density when the voltage is “0”.

As shown in FIG. 4, there is a correlation that the larger the current density being the value of the current flowing in each of the unit membrane electrode assembles 10 per area 1 cm², the lower the voltage generated in the unit membrane electrode assembly 10. Since the unit membrane electrode assemblies 10 are electrically connected in series, the values of the currents flowing in all the unit membrane electrode assemblies 10 are equal to one another. If the area of the surface of the unit membrane electrode assembly 10 with the smallest area is 90% of the area of the surface of the unit membrane electrode assembly 10 with the largest area, the current density I₂ of the unit membrane electrode assembly 10 with the smallest area is 1.11 times the current density I₁ of the unit membrane electrode assembly 10 with the largest area, and as shown in FIG. 4, the voltage V₂ generated in the unit membrane electrode assembly 10 with the smallest area has a value lower than the voltage V₁ generated in the unit membrane electrode assembly 10 with the largest area.

An amount by which the voltage V₂ is lower than the voltage V₁ at this time depends on ratios of the current density I₁ and the current density I₂ to the current density Iₘₐₓ. Generally, in order to maximize the power (a product of voltage and current) generated in the fuel cell 1, the current density I₁ and the current density I₂ are often set to about 60 to 90% of the current density Iₘₐₓ. In such a case, a ratio (V₂/V₁) between the voltage V₂ and the voltage V₁ is larger than a ratio (I₂/I₁, here, 1.11) of the current density I₂ and the current density I₁, and the power generation in the unit membrane electrode assembly 10 with the largest area is caused with a high voltage and power generation in the unit membrane electrode assembly 10 with the smallest area is caused with a low voltage.

In order to prevent such a state, preferably, the areas of the surfaces of the unit membrane electrode assemblies 10 are practically equal to one another, and even when they are not equal to one another, their ratio is preferably equal to the aforesaid current density ratio (1.11) or less, and the area of the surface of the unit membrane electrode assembly 10 with the smallest area is set to 90% or more of a value of the area of the surface of the unit membrane electrode assembly 10 with the largest area. Further, this ratio is preferably close to 100%, and is more preferably 95% or more.

Though the example where the membrane electrode assembly group 5 includes the four unit membrane electrode assemblies 10 is shown above, it should be noted that the number of the unit membrane electrode assemblies 10 included in the membrane electrode assembly group 5 is not limited to this and may be any plural number.

Examples of catalysts contained in the anode catalyst layers 11 and the cathode catalyst layers 14 of the unit membrane electrode assemblies 10 are elemental substances of platinum-group elements such as Pt, Ru, Rh, Ir, Os, and Pd, alloys containing a platinum-group element, and the like. For the anode catalyst layers 11, it is preferable to use, for example, Pt—Ru, Pt—Mo, or the like having high resistance against methanol, carbon monoxide, and the like. For the cathode catalyst layers 14, it is preferable to use, for example, Pt, Pt—Ni, Pt—Co, or the like. However, the catalysts are not limited to these, and various kinds of substances having catalytic activity can be used. The catalysts may be supported catalysts using a conductive carrier such as a carbon material or may be non-supported catalysts.

Examples of a proton-conductive material forming the electrolyte membrane 17 are fluorine-based resins (Nafion (product name, manufactured by Du Pont), Flemion (product name, manufactured by Asahi Glass Co., Ltd.), Aciplex (product name, manufactured by Asahi Kasei Industry, and the like)) such as a perfluorosulfonic acid polymer having a sulfonic acid group, organic materials such as hydrocarbon-based resin having a sulfonic acid group, and inorganic materials such as tungstic acid and phosphotungstic acid. Other examples used as the proton conductive material forming the electrolyte membrane 17 are a copolymer film of a trifluorostyrene derivative, a polybenzimidazole film impregnated with phosphoric acid, an aromatic polyetherketone sulfonic acid film, an aliphatic hydrocarbon resin film, and the like. However, the proton-conductive electrolyte membrane 17 is not limited to any of these and may be any capable of transporting protons.

Here, the electrolyte membrane 17 in the membrane electrode assembly group 5 is a single film as shown in FIG. 1, that is, one common film is formed as the electrolyte membrane 17 for all the unit membrane electrode assemblies 10, but the electrolyte membranes 17 may be provided independently for the respective unit membrane electrode assemblies 10.

The anode gas diffusion layers 12 stacked on the anode catalyst layers 11 not only serve to uniformly supply ₜhe fuel to the anode catalyst layers 11 but also serve as current collectors of the anode catalyst layers 11. The cathode gas diffusion layers 15 stacked on the cathode catalyst layers 14 not only serve to uniformly supply an oxidant to the cathode catalyst layers 14 but also serve as current collectors of the cathode catalyst layers 14. The anode gas diffusion layers 12 and the cathode gas diffusion layers 15 are each made of a porous carbonaceous material such as carbon paper, carbon cloth, or carbon silk, a porous substance or mesh made of a metal material such as titanium, a titanium alloy, stainless steel, or gold, or the like.

The anode conductive layers 18 stacked on surfaces of the anode gas diffusion layers 12 and the cathode conductive layers 19 stacked on surfaces of the cathode gas diffusion layers 15 are each made of, for example, a porous layer (for example, mesh or the like) or a foil made of a metal material such as gold or nickel, a complex material in which a conductive metal material such as stainless steel (SUS) is coated with a highly conductive metal such as gold, or the like. Among these, the anode conductive layers 18 and the cathode conductive layers 19 are each preferably made of a thin film having a plurality openings formed in correspondence to the unit membrane electrode assemblies 10, and through the openings, the fuel from the openings 31 of the fuel distribution layer 30 provided to face the unit membrane electrode assemblies 10 is led to the unit membrane electrode assemblies 10. Incidentally, the anode conductive layers 18 and the cathode conductive layers 19 are structured so as to prevent the leakage of the fuel and the oxidant from peripheral edges thereof. Further, between the electrolyte membrane 17 and the anode conductive layers 18 and between the electrolyte membrane 17 and the cathode conductive layers 19, O-rings 20 made of rubber are interposed respectively, and the O-rings 20 prevent the fuel leakage and the oxidant leakage from the unit membrane electrode assemblies 10. Here, the fuel cell 1 including the anode conductive layers 18 and the cathode conductive layers 19 is shown, but without the anode conductive layers 18 and the cathode conductive layers 19 being provided, the anode gas diffusion layers 12 and the cathode gas diffusion layers 15 may function not only as the diffusion layers as described above but also as the conductive layers. Further, in the fuel cell 1 shown in FIG. 1, the O-rings 20 are provided individually for the respective unit membrane electrode assemblies 10, but for the adjacent unit membrane electrode assemblies 10, the common O-ring 20 may be provided between the electrolyte membrane 17 and the anode conductive layers 18, and the common O-ring 20 may be provided between the electrolyte membrane 17 and the cathode conductive layers 19.

The moisture retention layer 50 is impregnated with part of water generated in the cathode catalyst layers 14 to prevent the transpiration of the water and promote the uniform diffusion of air to the cathode catalyst layers 14. The moisture retention layer 50 is formed by a flat plate made of a polyethylene porous film or the like, for instance.

The surface cover 60 adjusts an intake amount of air, and for the adjustment, the number, the size, or the like of the air inlet ports 61 are changed. Functioning to enhance adhesiveness between the constituent members by pressing the stack including the membrane electrode assembly group 5, the surface cover 60 is preferably made of metal such as SUS304, for instance, but is not limited to this.

The fuel supply mechanism 40 mainly includes a fuel storage part 41, a fuel supply part main body 42, and a channel 44.

A liquid fuel F appropriate for the unit membrane electrode assemblies 10 is stored in the fuel storage part 41. The fuel storage part 41 is made of a material that is not melted or deteriorated by the liquid fuel F. Concrete examples used as the material forming the fuel storage part 41 are polyethylene (PE), polypropylene (PP), polyetheretherketone (PEEK; trademark of Victrex), and the like. Incidentally, a fuel supply port, not shown, for supplying the liquid fuel F is provided in the fuel storage part 41.

Examples of the liquid fuel F include methanol fuels such as methanol aqueous solutions with various concentrations and pure methanol. The liquid fuel F is not limited to the methanol fuel. The liquid fuel F may be, for example, an ethanol fuel such as an ethanol aqueous solution or pure ethanol, a propanol fuel such as a propanol aqueous solution or pure propanol, a glycol fuel such as a glycol aqueous solution or pure glycol, or a liquid fuel of dimethyl ether, formic acid or the like. In any case, a liquid fuel according to the unit membrane electrode assemblies 10 is stored in the fuel storage part 41. In particular, a methanol aqueous solution whose fuel concentration is over 80 mol % or a pure methanol liquid is suitable.

The fuel supply part main body 42 includes a fuel supply part 43 formed by a concave portion for flatly dispersing the liquid fuel F in order to uniformly supply the supplied liquid fuel F to the fuel distribution layer 30. The fuel supply part 43 is connected to the fuel storage part 41 via the channel 44 for the liquid fuel F made of a pipe or the like. The liquid fuel F is led from the fuel storage part 41 to the fuel supply part 43 via the channel 44, and the led liquid fuel and/or a vaporized component generated by the vaporization of the liquid fuel F is (are) supplied to the unit membrane electrode assemblies 10 via the fuel distribution layer 30 and the anode conductive layers 18.

The channel 44 is made of a material that is not melted or deteriorated by the liquid fuel F. Concrete materials forming the channel 44 are metals such as stainless steel, copper, and aluminum, materials in which inner surfaces of these metals are plated with gold or the like, materials coated with resin, rubber, a coating material, or the like, resins such as polyethylene (PE), polypropylene (PP), polystyrene (PS), polyethylene telephthalate (PET), nylon, polyetheretherketone (PEEK), polytetrafluoroethylene (PTFE), tetrafluoroethylene perfluoroalkyl vinyl ether copolymer (PFA), polyvinyl chloride (PVC), polyimide (PI), and silicone resin, rubber such as ethylene propylene rubber (EPDM) and fluorine rubber, and so on. Further, the channel 44 is not limited to a pipe independent of the fuel supply part 43 and the fuel storage part 41. For example, when the fuel supply part 43 and the fuel storage part 41 are stacked to be integrated, the channel 44 may be a channel for the liquid fuel F connecting them. That is, it is only necessary that the fuel supply part 43 communicates with the fuel storage part 41 via a channel or the like.

The liquid fuel F stored in the fuel storage part 41 can be sent to the fuel supply part 43 via the channel 44 by being dropped with the use of gravity. Further, by filling a porous body in the channel 44, the liquid fuel F stored in the fuel storage part 41 may be sent to the fuel supply part 43 by capillary action. Further, as shown in FIG. 5, by providing a pump 80 in part of the channel 44, the liquid fuel F stored in the fuel storage part 41 may be forcibly sent to the fuel supply part 43.

The pump 80 functions as a supply pump simply sending the liquid fuel F from the fuel storage part 41 to the fuel supply part 43 and does not have a function as a circulation pump circulating an excessive amount of the liquid fuel F supplied to the unit membrane electrode assemblies 10. Not circulating the fuel, the fuel cell 1 including the pump 80 has a different structure from the structure of a conventional active type and also has a different structure from the structure of a pure passive type such as a conventional internal vaporization type, and corresponds to what is called a semi-passive type. The kind of the pump 80 functioning as a fuel supplier is not limited to a specific one, but a rotary vane pump, an electroosmotic flow pump, a diaphragm pump, a squeeze pump, or the like is preferably used in view of that each of them is capable of sending a small amount of the liquid fuel F with good controllability and can be reduced in size and weight. The rotary vane pump rotates a vane by a motor for fuel sending. The electroosmotic flow pump uses a sintered porous body such as silica causing an electroosmotic phenomenon. The diaphragm pump sends liquid by driving a diaphragm by an electromagnet or piezoelectric ceramics. The squeeze pump squeezes and sends the fuel by pressing part of a fuel channel having flexibility. Among them, the electroosmotic flow pump or the diaphragm pump having the piezoelectric ceramics is preferably used in view of the strength of driving power and the like. When the pump 80 is provided as described above, the pump 80 is electrically connected to a controller (not shown) and the controller controls a supply amount of the liquid fuel F supplied to the fuel supply part 43.

The fuel distribution layer 30 is made of, for example, a flat plate in which a plurality of openings 31 are formed, and is sandwiched between the anode gas diffusion layers 12 of the unit membrane electrode assemblies 10 and the fuel supply part 43. The fuel distribution layer 30 is made of a material not allowing the permeation of the vaporized component of the liquid fuel F and the liquid fuel F, and concretely, is made of, for example, polyethylene telephthalate (PET) resin, polyethylene naphthalate (PEN) resin, polyimide-based resin, or the like. Alternatively, the fuel distribution layer 30 may be made of a gas-liquid separation film separating the vaporized component of the liquid fuel F and the liquid fuel F and allowing the permeation of the vaporized component to the unit membrane electrode assembly 10 side. As the gas-liquid separation film, used is, for example, silicone rubber, a low-density polyethylene (LDPE) thin film, a polyvinyl chloride (PVC) thin film, a polyethylene telephthalate (PET) thin film, a fluororesin (for example, polytetrafluoroethylene (PTFE), tetrafluoroethylene perfluoroalkyl vinyl ether copolymer (PFA) or the like) micro-porous film, or the like.

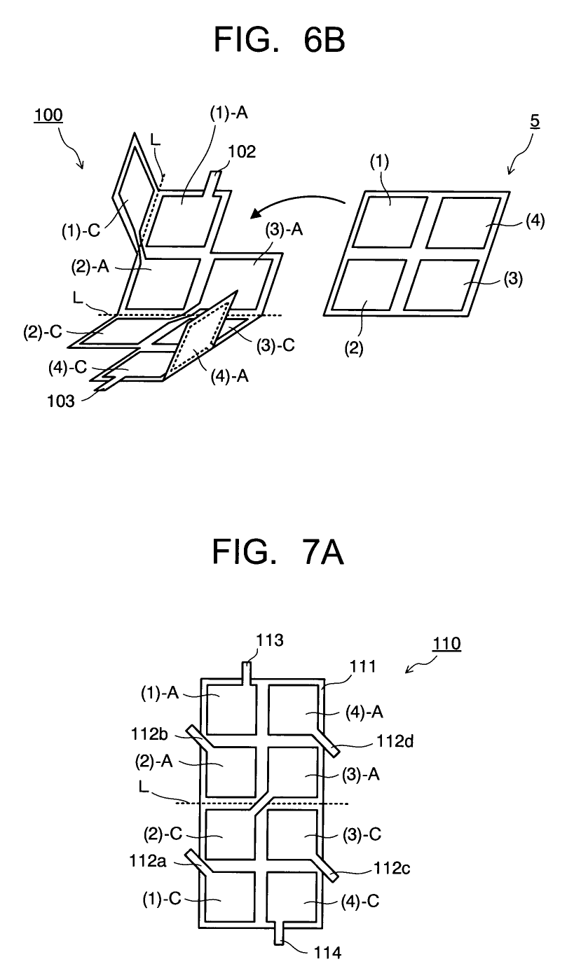

Next, a structure example of the anode conductive layers 18 and the cathode conductive layers 19 when the anode conductive layers 18 and the cathode conductive layers 19 are formed in the fuel cell 1 will be described with reference to FIG. 6A to FIG. 8.

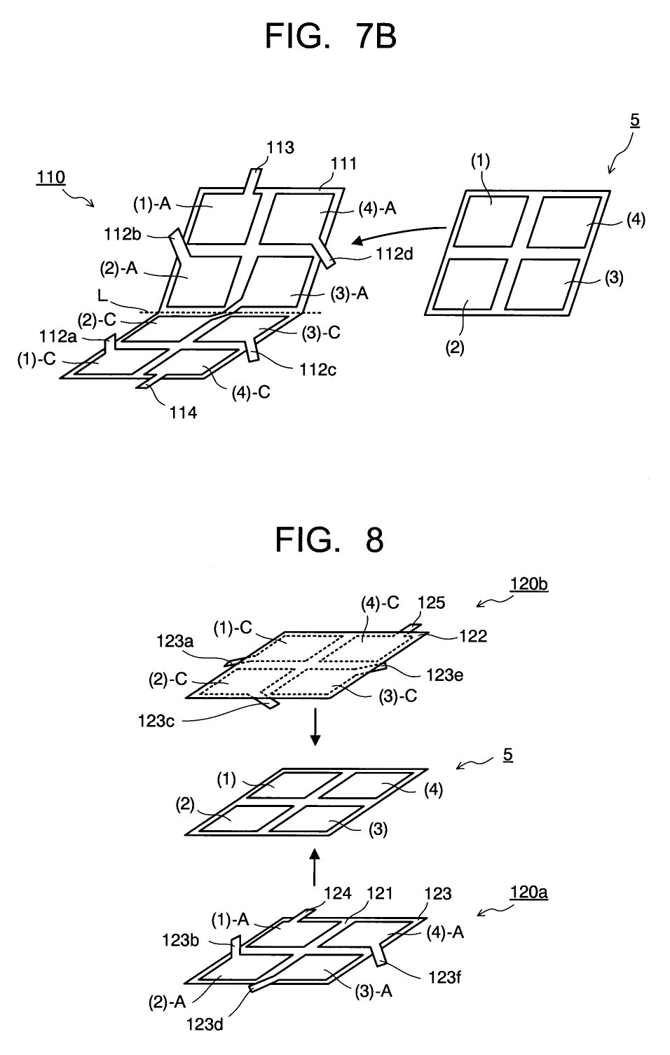

FIG. 6A is a developed view of a conductive layer-forming sheet 100 for forming the anode conductive layers 18 and the cathode conductive layers 19. FIG. 6B is an explanatory view showing a process of forming the anode conductive layers 18 and the cathode conductive layers 19 from the conductive layer-forming sheet 100 shown in FIG. 6A. FIG. 7A is a developed view of a conductive layer-forming sheet 110 in another form for forming the anode conductive layers 18 and the cathode conductive layers 19, and FIG. 7B is an explanatory view showing a process of forming the anode conductive layers 18 and the cathode conductive layers 19 from the conductive layer-forming sheet 110 shown in FIG. 7A. FIG. 8 is an explanatory view showing a process of forming the anode conductive layers 18 and the cathode conductive layers 19 from conductive layer-forming sheets 120a, 120b in still another form for forming the anode conductive layers 18 and the cathode conductive layer 19.

Here, there is shown a structure example of the conductive layer-forming sheet in the structure where the four rectangular unit membrane electrode assemblies 10 are arranged in matrix around a given center point at predetermined intervals (see FIG. 2). Further, (1) to (4) in the drawing are signs denoting the unit membrane electrode assemblies 10, and “A” represents the anode conductive layer 18 and “C” represents the cathode conductive layer 19. For example, a portion denoted by (1)-“A” is a conductive sheet for forming the anode conductive layer 18 of the unit membrane electrode assembly 10 represented by (1), and a portion denoted by (1)-“C” is a conductive sheet for forming the cathode conductive layer 19 of the unit membrane electrode assembly 10 represented by (1).

First, the conductive layer-forming sheet 100 shown in FIG. 6A and FIG. 6B will be described.

As shown in FIG. 6A, conductive sheets (((1)-“A”) to ((4) -“C”)) are arranged two-dimensionally and with a predetermined structure on one insulating sheet 101 so as to correspond to the anodes (fuel electrodes) 13 and the cathodes (air electrodes) 16 of the respective unit membrane electrode assemblies 10 represented by (1) to (4).

Subsequently, as previously described, in order to electrically connect the unit membrane electrode assemblies 10 represented by (1) to (4) in series, predetermined ones of the conductive sheets are electrically connected. Here, the electrical connection is performed between the conductive sheet ((1)-“C”) and the conductive sheet ((2)-“A”), between the conductive sheet ((2)-“C”) and the conductive sheet ((3)-“A”), and between the conductive sheet ((3)-“C”) and the conductive sheet ((4)-“A”). Further, an output terminal 102 is provided in the conductive sheet ((1)-“A”) and an output terminal 103 is provided in the conductive sheet ((4)-“C”).

As shown in FIG. 6B, the above-described conductive layer-forming sheet 100 is folded along fold lines L shown in FIG. 6A and FIG. 6B, with the membrane electrode assembly group 5 composed of the unit membrane electrode assemblies 10 represented by (1) to (4) being interposed, so that the anode conductive layers 18 and the cathode conductive layers 19 corresponding to the respective unit membrane electrode assemblies 10 represented by (1) to (4) are formed and the unit membrane electrode assemblies 10 are electrically connected in series.

Next, the conductive layer-forming sheet 110 shown in FIG. 7A and FIG. 7B will be described.

As shown in FIG. 7A, conductive sheets ((1)-“A”) to ((4) -“C”)) are arranged two-dimensionally and with a predetermined structure on one insulating sheet 111 so as to correspond to the anodes (fuel electrodes) 13 and the cathodes (air electrodes) 16 of the respective unit membrane electrode assemblies 10 represented by (1) to (4).

Subsequently, as previously described, in order to electrically connect the unit membrane electrode assemblies 10 represented by (1) to (4) in series, predetermined ones of the conductive sheets are electrically connected. Here, the conductive sheet ((2)-“C”) and the conductive sheet ((3)-“A”) are electrically connected. Further, contact terminals 112a, 112b, 112c, 112d are provided in the conductive sheet ((1)-“C”), the conductive sheet ((2)-“A”), the conductive sheet ((3)-“C”), and the conductive sheet ((4) -“A”) respectively, and at the time of assembly, the conductive sheet ((1)-“C”) and the conductive sheet ((2)-“A”) are electrically connected by the contact terminals 112a, 112b, and the conductive sheet ((3)-“C”) and the conductive sheet ((4)-“A”) are electrically connected by the contact terminals 112c, 112d. Further, an output terminal 113 is provided in the conductive sheet ((1)-“A”) and an output terminal 114 is provided in the conductive sheet ((4)-“C”).

As shown in FIG. 7B, the above-described conductive layer-forming sheet 110 is folded along fold lines L shown in FIG. 7A and FIG. 7B, with the membrane electrode assembly group 5 composed of the unit membrane electrode assemblies 10 represented by (1) to (4) being interposed, and the contact terminals are connected in the above-described manner, so that the anode conductive layers 18 and the cathode conductive layers 19 corresponding to the respective unit membrane electrode assemblies 10 represented by (1) to (4) are formed and further the unit membrane electrode assemblies 10 represented by (1) to (4) are electrically connected in series.

Next, the conductive layer-forming sheets 120a, 120b shown in FIG. 8 will be described.

As shown in FIG. 8, conductive sheets (((1)-“A”) to ((4)-“A”)) are arranged two-dimensionally on one insulating sheet 121 so as to correspond to the anodes (fuel electrodes) 13 of the unit membrane electrode assemblies 10 represented by (1) to (4), whereby the conductive layer-forming sheet 120a on the fuel electrode side is formed. Further, conductive sheets (((1)-“C”) to ((4)-“C”)) are arranged two-dimensionally on one insulating sheet 122 so as to correspond to the cathodes (air electrodes) 16 of the unit membrane electrode assemblies 10 represented by (1) to (4), whereby the conductive layer-forming sheet 120b on the air electrode side is formed. Further, contact terminals 123a, 123b, 123c, 123d, 123e, 123f are provided in the respective conductive sheets except the conductive sheet ((1)-“A”) and the conductive sheet ((4)-“C”), and at the time of assembly, the conductive sheet ((1)-“C”) and the conductive sheet ((2)-“A”) are electrically connected by the contact terminals 123a, 123b, the conductive sheet ((2)-“C”) and the conductive sheet ((3) -“A”) are electrically connected by the contact terminals 123c, 123d, and the conductive sheet ((3)-“C”) and the conductive sheet ((4) -“A”) are electrically connected by the contact terminals 123e, 123f. Further, an output terminal 124 is provided in the conductive sheet ((1)-“A”) and an output terminal 125 is provided in the conductive sheet ((4)-“C”).

The above-described conductive layer-forming sheets 120a, 120b are set to face each other via the membrane electrode assembly group 5 composed of the unit membrane electrode assemblies 10 represented by (1) to (4), and the contact terminals are connected in the above-described manner, so that the anode conductive layers 18 and the cathode conductive layers 19 corresponding to the unit membrane electrode assemblies 10 represented by (1) to (4) are formed and the unit membrane electrode assemblies 10 are electrically connected in series.

Instead of electrically connecting the adjacent anode conductive layers 18 and cathode conductive layers 19 by the above-described methods, the adjacent anode conductive layers 18 and cathode conductive layers 19 may be simply connected by using lead wires or the like, for instance, but the connection by the above-described methods facilitates the fabrication of the fuel cell 1 and makes it possible to reduce the volume of the whole fuel cell.

The above-described insulating sheets are each made of, for example, polyethylene telephthalate (PET) or the like. Further, in portions, of the insulating sheets, where the conductive sheets are disposed, a plurality of holes are formed so as to allow a fuel, air, and so on to pass therethrough.

Next, the operation in the above-described fuel cell 1 will be described with reference to FIG. 1.

The liquid fuel F led out from the fuel storage part 41 toward the fuel supply part 43 via the channel 44 is led, as it is or in a state where it is mixed with a vaporized fuel generated by the vaporization of the liquid fuel F, to the anode conductive layers 18 of the unit membrane electrode assemblies 10 from the fuel distribution layer 30. The fuel led to the anode conductive layers 18 of the unit membrane electrode assemblies 10 is supplied to the anode gas diffusion layers 12, diffuses in the anode gas diffusion layers 12, and is supplied to the anode catalyst layers 11. When a methanol fuel is used as the liquid fuel, an internal reforming reaction of methanol expressed by the following expression (1) occurs in the anode catalyst layers 11.

CH₃OH+H₂O→CO₂+6H⁺+6e⁻ expression (1)

When pure methanol is used as the methanol fuel, methanol is reformed by the internal reforming reaction of the above expression (1) with water generated in the cathode catalyst layers 14 or water in the electrolyte membrane 17, or is reformed by another reaction mechanism not requiring water.

Electrons (e⁻) generated in this reaction are led to the outside via the current collectors, and after working as what is called electricity to operate a portable electronic device or the like, the electrons (e⁻) are led to the cathodes (air electrodes) 16. Further, protons (H⁺) generated in the internal reforming reaction of the expression (1) are led to the cathodes (air electrodes) 16 via the electrolyte membrane 17. Air is supplied as the oxidant to the cathodes (air electrodes) 16. In the cathode catalyst layers 14, the electrons (e⁻) and the protons (H⁺) having reached the cathodes (air electrodes) 16 make a reaction expressed by the following expression (2) with oxygen in the air, and the power generation reaction is accompanied by the generation of water.

(3/2)O₂+6e⁻+6H⁺→3H₂O expression (2)

The above-described internal reforming reaction smoothly takes place and high and stable output can be obtained in the fuel cell 1.

According to the fuel cell 1 of the embodiment according to the present invention described above, the membrane electrode assembly group 5 can be structured such that the plural unit membrane electrode assemblies 10 are uniformly arranged two-dimensionally so as to be predetermined intervals apart from one another in the circumferential direction around a given center point, with the same electrodes being set on the same side. Consequently, the unit membrane electrode assemblies 10 have the same temperature distribution state, that is, the same temperature uneven state, and substantially the same output characteristic is obtained in the unit membrane electrode assemblies 10. Further, since substantially the same output characteristic is obtained in the unit membrane electrode assemblies 10, it is possible to prevent the occurrence of the polarity reversal caused by unevenness in outputs of the unit membrane electrode assemblies 10 when the unit membrane electrode assemblies 10 are electrically connected in series. Further, the prevention of the occurrence of the polarity reversal can prevent an abnormal reaction electrochemically occurring in the catalysts included in the anode catalyst layers, the carbon materials carrying the catalysts, and so on, and can prevent the deterioration of these materials.

Further, as described above, by forming the anode conductive layers 18 and the cathode conductive layers 19 by using the conductive layer-forming sheet and electrically connecting the predetermined anode conductive layers 18 and cathode conductive layers 19, it is possible to electrically connect the unit membrane electrode assemblies 10 in series. Further, the fabrication of the fuel cell 1 becomes easy, and the volume of the whole fuel cell can be reduced.

(Fuel cell 300 Including Other Arrangement and Structure of Unit Membrane Electrode Assemblies)

Here, a fuel cell 300 according to the present invention including the arrangement and structure of unit membrane electrode assemblies different from the above-described arrangement and structure of the unit membrane electrode assemblies of the fuel cell 1 will be described.

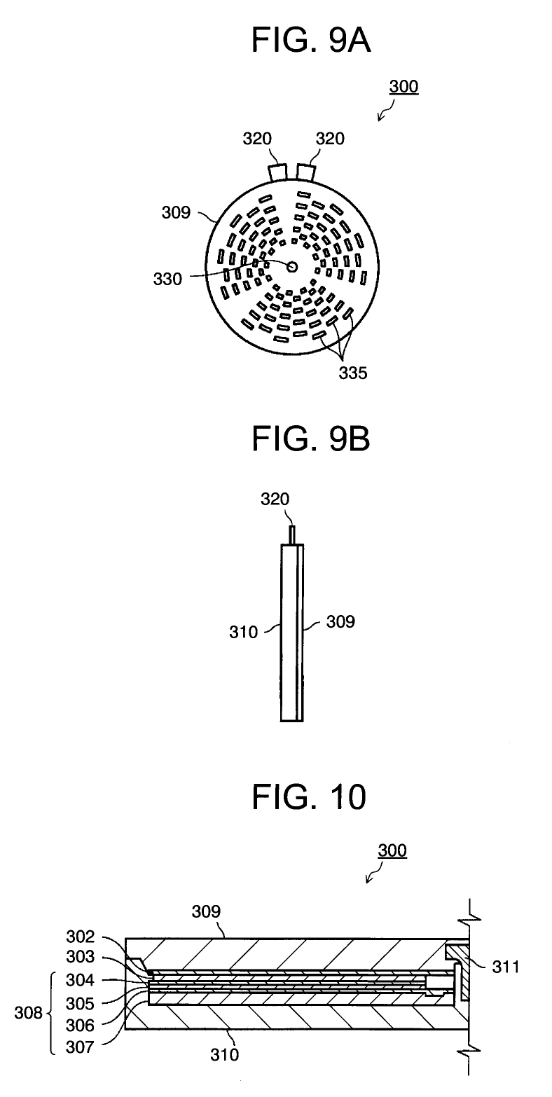

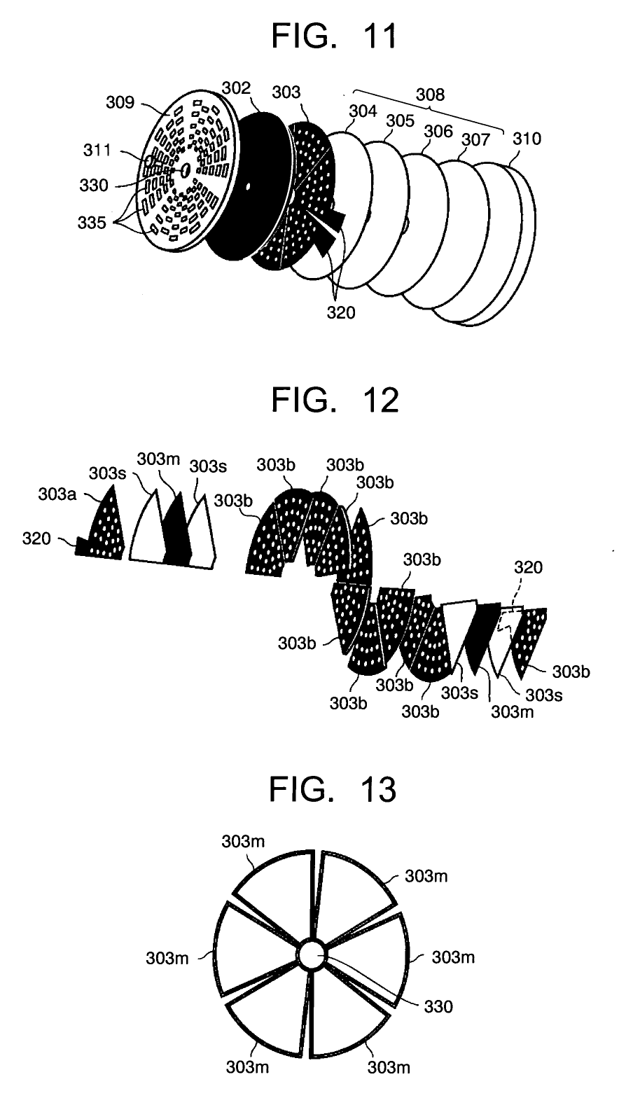

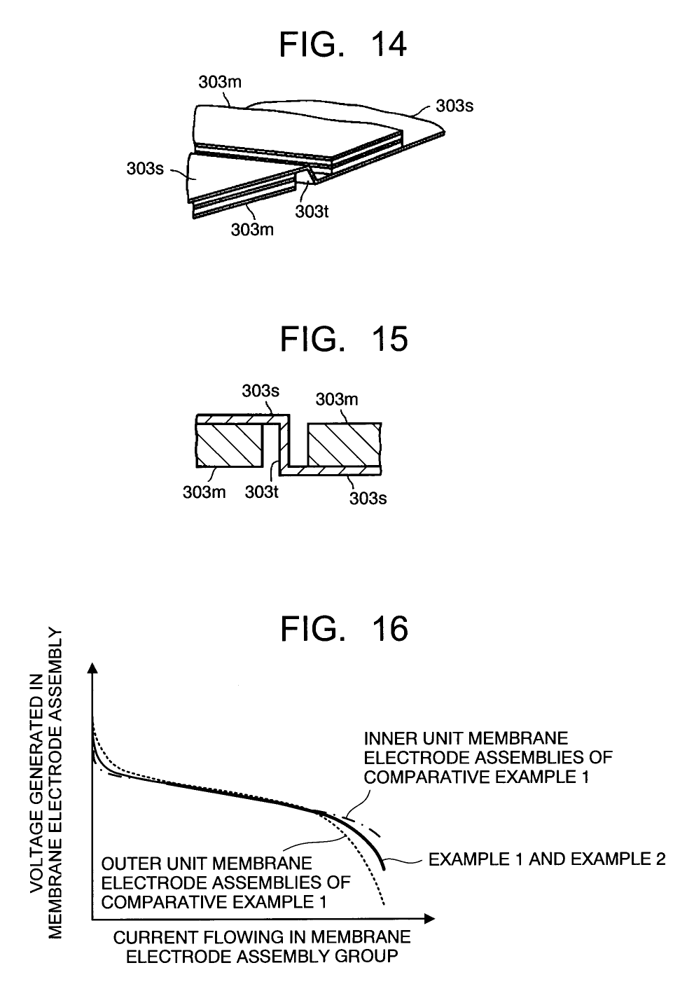

FIG. 9A is a plane view when the fuel cell 300 according to the present invention is seen from an air electrode side. FIG. 9B is a plane view showing a side surface of the fuel cell 300 according to the present invention. FIG. 10 is a partial cross-sectional view showing a rough structure of the fuel cell 300 according to the present invention. FIG. 11 is an exploded perspective view showing the fuel cell 300 according to the present invention disassembled into constituent elements. FIG. 12 is an exploded perspective view showing a membrane electrode assembly/current collector assembly further disassembled into constituent elements. FIG. 13 is a plane view showing a hexagonal membrane electrode assembly/current collector assembly having six membrane electrode assembly segments. FIG. 14 is a perspective view showing an essential part of a sealing member disposed between the adjacent membrane electrode assembly segments. FIG. 15 is a cross-sectional view showing an essential part of the sealing member disposed between the adjacent membrane electrode assembly segments.

As shown in FIG. 9A and FIG. 9B, the fuel cell 300 is covered by an outer case cover 309 and an outer case box 310 both of which have a circular outer periphery, and as shown in FIG. 10, a moisture retention plate 302, a membrane electrode assembly/current collector assembly (MEA/CC assembly) 303, and a gas-liquid separation film/diffusion layer unit 308 are housed in the outer case cover 309 and the outer case box 310 while being stacked in order. Here, the current collector functions as a conductive layer, and the membrane electrode assembly mentioned here is a membrane electrode assembly group in which a plurality of unit membrane electrode assemblies are arranged.

Further, at the centers of the outer case cover 309 and the outer case box 310, boltholes 330 are formed respectively. As shown in FIG. 11, a bolt 311 is screwed into the bolthole 330 of the outer case cover 309 and the bolt 311 is engaged with a not-shown nut on the outer case box 310 side, whereby the outer case cover 309 and the outer case box 310 are fastened to each other to be integrated. Owing to such a bolt-fastened structure, a stack composed of the moisture retention plate 302, the membrane electrode assembly/current collector assembly (MEA/CC assembly) 303, and the gas-liquid separation film/diffusion layer unit 308 which are housed inside is uniformly loaded with a predetermined contact pressure.

Incidentally, similar boltholes, not shown, are also formed at a plurality of places of peripheral edge portions of main surfaces of the circular outer case cover 309 and outer case box 310. By using bolts and nuts, the outer case cover 309 and the outer case box 310 are fastened to each other with a predetermined pressing force. Further, outer peripheral end portions of the circular outer case cover 309 and outer case box 310 can be entirely or partly caulked, though this structure is not shown. On an immediately inner side of the outer peripheral end portions of the outer case cover 309 and the outer case box 310, a not-shown O-ring is fit. Accordingly, the whole periphery is liquid-tightly sealed so that a liquid fuel (a pure methanol liquid or a methanol aqueous solution) inside does not leak out of the fuel cell. Such an O-ring sealed structure can be a double sealed structure using two-stages of O-rings.

The outer case cover 309 and the outer case box 310 are each made of a metal plate such as stainless steel (for example SUS304). The moisture retention plate 302 not only functions to prevent the transpiration of water generated in air electrodes but also functions as an auxiliary diffusion layer to uniformly lead air as an oxidant to the air electrodes to promote the uniform diffusion of the oxidant to catalyst layers of the air electrodes. As the moisture retention plate 302, a porous film whose porosity is 20 to 60%, or the like is preferably used, for instance.

As shown in FIG. 9A, FIG. 9B, and FIG. 11, a plurality of air vents 335 are formed in the main surface of the outer case cover 309. These air vents 335 are intended to supply air as the oxidant toward a cathode (air electrode) side of the MEA/CC assembly 303 via the moisture retention plate 302.

In the outer case box 310, a fuel storage chamber with a predetermined capacity, though not shown, is formed, and a not-shown liquid fill port of a fuel supply mechanism communicates with the fuel storage chamber. In the fuel storage chamber, fibrous or porous diffusion layers 305, 306, 307 such as carbon paper are housed. The diffusion layers 305, 306, 307 are passive liquid feed members for delivering the liquid fuel to an anode (fuel electrode) side of the membrane electrode assembly by capillary action and are arbitrarily disposed. The diffusion layers 305, 306, 307 function as part of the fuel supply mechanism supplying the fuel to anodes (fuel electrodes).

Alternatively, some of the diffusion layers 305, 306, 307 may be a liquid fuel-impregnated layer. For example, the lowest diffusion layer 307 may be the liquid fuel-impregnated layer. The lowest diffusion layer 307 may be made of, for example, porous fiber such as porous polyester fiber or porous olefin-based resin, open-cell porous resin, or the like. Even when the liquid fuel in a fuel supply source reduces or even when a fuel cell main body is set aslope and accordingly the fuel supply becomes uneven, the liquid fuel-impregnated layer can supply the liquid fuel uniformly to a gas-liquid separation film 304. As a result, it is possible to uniformly supply the vaporized liquid fuel to anode catalyst layers of the membrane electrode assembly. Note that the diffusion layer 307 may be made of any of various kinds of water-absorbing polymers such as acrylic acid-based resin, besides polyester fiber. That is, the diffusion layer 307 may be made of any material such as a sponge or a fiber aggregate capable of retaining liquid by utilizing permeability of the liquid. As described above, the liquid fuel-impregnated part is effective for supplying an appropriate amount of the liquid fuel irrespective of the posture of the fuel cell main body.

Further, the gas-liquid separation film 304 is arbitrarily inserted between the plural diffusion layers 305, 306, 307 and the anodes (fuel electrodes) of the MEA/CC assembly 303. The gas-liquid separation film 304 has a property of allowing the permeation of only a vaporized component of the fuel having diffused and moved in the diffusion layers 305, 306, 307 and shutting off a liquid component of the liquid fuel. The gas-liquid separation film 304 is made of, for example, a silicon sheet, a polytetrafluoroethylene (PTFE) sheet, or the like having a large number of thin holes. Concretely, it is made of, for example, a polytetrafluoroethylene (PTFE) sheet with a 0.01 mm thickness, or the like.

The liquid fuel is injected from a not-shown fuel cartridge to the fuel supply mechanism, moves from the fuel supply mechanism to the fuel storage chamber, permeates through the diffusion layers 305, 306, 307 in order by capillary force, and reaches the gas-liquid separation film 304. Then, the vaporized fuel permeates through the gas-liquid separation film 304 to reach the anodes (fuel electrodes) of the membrane electrode assembly.

Though the above-described embodiment has the structure in which the fuel storage chamber is provided under the membrane electrode assembly, the present invention is not limited to this, and a channel may be provided and connected for the supply of the fuel from the fuel storage part to the membrane electrode assembly. Further, the description is given, taking the passive-type fuel cell as an example of the structure of the fuel cell main body, but the present invention is also applicable to an active-type fuel cell and further to a fuel cell called a semi-passive type using a pump or the like for part of the fuel supply. In the semi-passive type fuel cell, a fuel supplied from a fuel storage chamber to a membrane electrode assembly is used for a power generation reaction and is not thereafter circulated to be returned to the fuel storage part. The semi-passive type fuel cell does not circulate the fuel and thus is different from a conventional active type and does not impair the size reduction and the like of a device. Further, the fuel cell uses a pump for the fuel supply and is different from a pure passive type such as a conventional internal vaporization type. Therefore, the fuel cell is called a semi-passive type as described above. Incidentally, in the fuel cell of the semi-passive type, a fuel shutoff valve may be disposed instead of the pump, provided that the fuel is supplied from the fuel storage part to the membrane electrode assembly. In this case, the fuel shutoff valve is provided in order to control the supply of the liquid fuel via the channel.

Next, the membrane electrode assembly/current collector assembly (MEA/CC assembly) 303 and the gas-liquid separation film/diffusion layer unit 308 housed in the outer case cover 309 and the outer case box 310 will be described in detail.

As shown in FIG. 11, the moisture retention plate 302, the MEA/CC assembly 303, the gas-liquid separation film 304, and the three diffusion layers 305, 306, 307 are housed in the outer case cover 309 and the outer case box 310 while being stacked in order from the outer case cover 309 side. As shown in FIG. 9A and FIG. 9B, positive and negative terminals 320 project outward from outer peripheral side surfaces of the outer case cover 309 and the outer case box 310. As shown in FIG. 11 and FIG. 12, the pair of these terminals 320 project outward from outer peripheral end portions of a positive current collector 303a and a negative current collector 303b of the MEA/CC assembly 303. Note that the negative current collector 303b corresponds to the aforesaid anode conductive layer and the positive current collector 303a corresponds to the aforesaid cathode conductive layer.

The positive current collector 303a, the negative current collector 303b, and the membrane electrode assembly segment (MEA segment) 303m are power generating elements with a multi-electrode structure having six unit electrodes (unit cells) in this embodiment. Here, the MEA segment 303m corresponds to the aforesaid unit membrane electrode assembly. These unit cells are arranged side by side substantially coplanarly and are electrically connected in series by not-shown wiring. That is, as shown in FIG. 12, the positive current collector 303a, the negative current collector 303b, the MEA segment 303m, and a sealing member 303s each are equally divided into six fan-shaped portions with respect to the bolthole 330 as a center.

As shown in FIG. 13, the six MEA segments 303m are arranged so as to be predetermined intervals apart from one another, with their outer peripheries trimmed by insulating materials, and form a circular shape as a whole. In the MEA segments 303m and so on of this embodiment, a circle is divided into six small units, but it should be noted that the present invention is not limited to this, and a circle may be divided into two, into three, into four, into five, into seven, into eight, into nine, into ten, into eleven, or into twelve. Further, in this embodiment, the whole shape is circular but may be polygonal such as triangular, quadrangular, pentagonal, heptagonal, octagonal, nonagonal, decagonal, hendecagonal, or dodecagonal.

As shown in FIG. 12, in the positive current collectors 303a, the negative current collectors 303b, and the MEA segments 303m except the sealing members 303s, a plurality of passage holes are formed so that the vaporized fuel or air as the oxidant can flow freely inside the membrane electrode assembly.

The fuel injected from the fuel supply mechanism is supplied to the anode (fuel electrode) side of the MEA/CC assembly 303. In the MEA/CC assembly 303, the fuel diffuses in anode gas diffusion layers to be supplied to the anode catalyst layers. When a methanol fuel is used as the liquid fuel, an internal reforming reaction of methanol occurs in the anode catalyst layers. When pure methanol is used as the methanol fuel, the internal reforming reaction is caused by the reaction of water generated in cathode catalyst layers or water in the electrolyte membrane with methanol. Alternatively, the internal reforming reaction is caused by another reaction mechanism not requiring water.

Electrons (e⁻) generated in this reaction are led to the outside via the current collector, and after working as what is called electricity to operate a portable electronic device or the like, the electrons (e⁻) are led to cathodes (air electrodes). Further, protons (H⁺) generated in the internal reforming reaction are led to the air electrodes via the electrolyte membrane. Air is supplied as the oxidant to the air electrodes. In the cathode catalyst layers, the electrons (e⁻) and the protons (H⁺) having reached the air electrodes react with oxygen in the air, and this reaction is accompanied by the generation of water.

When a methanol fuel is used as the liquid fuel, the internal reforming reaction of methanol expressed by the aforesaid expression (1) occurs in the anode catalyst layers. When pure methanol is used as the methanol fuel, the internal reforming reaction expressed by the aforesaid expression (1) is caused by the reaction of water generated in the anode catalyst layers or water in the electrolyte membrane with methanol. Alternatively, the internal reforming reaction is caused by another reaction mechanism not requiring water.

Electrons (e⁺) generated in this reaction are led to the outside via the current collector, and after working as what is called electricity to operate a portable electronic device or the like, the electrons (e⁺) are led to the cathodes (air electrodes). Further, protons (H⁺) generated in the internal reforming reaction of the expression (1) are led to the cathodes (air electrodes) via the electrolyte membrane. Air is supplied as the oxidant to the cathodes (air electrodes). In the cathode catalyst layers, the electrons (e⁻) and the protons (H⁺) having reached the cathodes (air electrodes) react with oxygen in the air according to the aforesaid expression (2) and this reaction is accompanied by the generation of water.

The membrane electrode assembly (MEA) of the MEA/CC assembly 303 includes: the cathodes (air electrodes) each composed of the cathode catalyst layer and a cathode gas diffusion layer; the anodes (fuel electrodes) each composed of the anode catalyst layer and the anode gas diffusion layer; and the proton conductive electrolyte membrane disposed between the cathode catalyst layers and the anode catalyst layers. Catalysts contained in the cathode catalyst layers and the anode catalyst layers are the same as the catalysts contained in the anode catalyst layers 11 and the cathode catalyst layers 14 forming the aforesaid fuel cell 1.

The electrolyte membrane is intended to transport the protons generated in the anode catalyst layers to the cathode catalyst layers, and is made of a material not having electron conductivity and capable of transporting the protons. This electrolyte membrane is made of the same material as that of the electrolyte membrane 17 forming the aforesaid fuel cell 1.

The cathode catalyst layers are stacked on the cathode gas diffusion layers and the anode catalyst layers are stacked on the anode gas diffusion layers. The cathode gas diffusion layers not only play a role of uniformly supplying the oxidant to the cathode catalyst layers but also serve as current collectors of the cathode catalyst layers. The anode gas diffusion layers not only play a role of uniformly supplying the fuel to the anode catalyst layers but also serve as current collectors of the anode catalyst layers.

An inner surface of each of the positive current collectors 303a is in contact with the cathode gas diffusion layer, and an inner surface of each of the negative current collectors 303b is in contact with the anode gas diffusion layer. The negative current collectors 303b and the positive current collectors 303a are each made of the same materials as those of the anode conductive layer 18 and the cathode conductive layer 19 forming the aforesaid fuel cell 1.

As shown in FIG. 14 and FIG. 15, the sealing member 303s, which functions as an insulating member, has a bent portion 303t and insulatingly seals a gap between the adjacent MEA segments 303m. Further, the sealing member 303s separates the anode (fuel electrode) side and the cathode (air electrode) side of each of the MEA segments 303m to prevent the occurrence of crossover which is the leakage of the unreacted fuel to the air electrode side. Desirably, the sealing member 303s is made of a rubber material whose fuel permeation amount is 9×10⁷ g/(m²·24 hr·atm) or less and whose specific volume resistivity is 10¹¹ to 10¹⁵ Ω·cm. This is because, when an amount of permeation is large, an amount of the fuel contributing to the power generation becomes small, which lowers fuel cell performance, and when sheet resistance is low, short circuit due to dielectric breakdown is likely to occur. As the rubber material, EPDM (ethylene propylene rubber), fluorine rubber, silicon rubber, or the like is usable.

As the liquid fuel, usable is a methanol fuel such as liquid methanol or a methanol aqueous solution. Here, a vaporized component of the liquid fuel refers to vaporized methanol when the liquid methanol is used as the liquid fuel, and refers to mixed gas containing a vaporized component of methanol and a vaporized component of water when the methanol aqueous solution is used as the liquid fuel. It should be noted that the liquid fuel is not limited to the methanol fuel but may be, for example, an ethanol fuel such as an ethanol aqueous solution or pure ethanol, a propanol fuel such as a propanol aqueous solution or pure propanol, a glycol fuel such as a glycol aqueous solution or pure glycol, a liquid fuel of dimethyl ether, formic acid, or the like. In any case, the liquid fuel appropriate for the fuel cell is used. In particular, a methanol aqueous solution whose fuel concentration is over 80 mol % or a pure methanol liquid is suitable.

According to the above-described embodiment, the divided small-unit MEA segments are disposed two-dimensionally in a circular arrangement or a polygonal arrangement and they are serially connected to form a multi-electrode series circuit, which is a structure remarkably excellent in space utilization efficiency. Further, it is possible to ensure a voltage high enough to drive a portable electronic device. This can improve volume energy density in the power generation part of the fuel cell. Accordingly, it is possible to obtain an output characteristic high enough to operate a cordless portable device such as a cellular phone, a portable audio device, a portable game player, or a laptop personal computer, and a compact and high-power power source for mobile devices is realized. Further, in this embodiment, when the MEA segments are formed as components compatible with each other, the kinds of the components reduces and it becomes easy to form the components as modules, facilitating the assembly. Therefore, mistakes during the assembly work are greatly reduced and manufacturing cost can be reduced.

Next, it will be described based on examples 1, 2 and a comparative example 1 that the fuel cell according to the present invention has an excellent output characteristic.

### Example 1

A fuel cell used in the example 1 will be described with reference to FIG. 1 and FIG. 2 since it includes the same structure as that of the fuel cell 1 shown in FIG. 1 and FIG. 2. Further, the formation of anode conductive layers 18 and cathode conductive layers 19 will be described with reference to FIG. 6A and FIG. 6B since these conductive layers are formed by using the aforesaid conductive layer-forming sheet 100.

First, a method of fabricating a membrane electrode assembly group 5 will be described.

A perfluorocarbon sulfonic acid solution as proton conductive resin and water and methoxypropanol as dispersion mediums were added to carbon black carrying anode catalyst particles (Pt:Ru=1:1), and the carbon black carrying the anode catalyst particles were dispersed, whereby paste was prepared. The obtained paste was applied on porous carbon paper (39.5 mm×21 mm rectangle) being an anode gas diffusion layer 12, whereby an anode catalyst layer 11 with a 100 μm thickness was obtained.

A perfluorocarbon sulfonic acid solution as proton conductive resin and water and methoxypropanol as dispersion mediums were added to carbon black carrying cathode catalyst particles (Pt), and the carbon black carrying the cathode catalyst particles were dispersed, whereby paste was prepared. The obtained paste was applied on porous carbon paper being a cathode gas diffusion layer 15, whereby a cathode catalyst layer 14 with a 100 μm thickness was obtained. Incidentally, the anode gas diffusion layer 12 and the cathode gas diffusion layer 15 have the same shape and size, and the anode catalyst layer 11 and the cathode catalyst layer 14 applied on these gas diffusion layers also have the same shape and size.

Four pieces of the anode catalyst layers 11 and four pieces of the cathode catalyst layers 14 fabricated in the above-described manner were prepared, the anode catalyst layers 11 and the cathode catalyst layers 14 were set to face each other, an electrolyte membrane 17 was interposed therebetween, and they were uniformly arranged two-dimensionally in matrix so as to be predetermined intervals apart from one another in a circumferential direction around a given center point, with the same catalyst layers being set on the same side. As the electrolyte membrane 17, a perfluorocarbon sulfonic acid film (product name: nafion film manufactured by Du Pont) with a 30 μm thickness and with a 10 to 20 wt % water content was used, and hot pressing was performed while the anode catalyst layers 11 and the cathode catalyst layers 14 were positioned so as to face each other, whereby the membrane electrode assembly group 5 was obtained.

Subsequently, as shown in FIG. 6A, conductive sheets ((1)-“A”) to ((4)-“C”)) were two-dimensionally arranged on one insulating sheet 101 so as to correspond to anodes (fuel electrodes) 13 and cathodes (air electrodes) 16 of unit membrane electrode assemblies 10 respectively. As the conductive sheets, gold foils each having a plurality of openings were used, and polyethylene telephthalate (PET) was used as the insulating sheet. Further, in the insulating sheet, at portions where the conductive sheets are disposed, 32 holes in a 2.5 mm×2.5 mm rectangular shape were formed per conductive sheet. By using this conductive layer-forming sheet 100, the anode conductive layers 18 and the cathode conductive layers 19 were formed on the unit membrane electrode assemblies 10 constituting the membrane electrode assembly group 5 by the above-described method. Here, the electrical connection was performed between the conductive sheet ((1)-“C”) and the conductive sheet ((2)-“A”), between the conductive sheet ((2)-“C”) and the conductive sheet ((3)-“A”), and between the conductive sheet ((3)-“C”) and the conductive sheet ((4)-“A”), whereby the unit membrane electrode assemblies 10 were electrically connected in series. Between the electrolyte membrane 17 and the anode conductive layers 18 and between the electrolyte membrane 17 and the cathode conductive layer 19, O-rings 20 made of rubber were interposed for sealing.

Further, as a moisture retention layer 50, used was a polyethylene porous film with a 500 μm thickness, 2 sec./100 cm³ air permeability (according to a measuring method defined in JIS P-8117), and 4000 g/(m²·24 h) water vapor permeability (according to a measuring method defined in JIS L-1099 A-1).

As a surface cover 60, a stainless steel plate (SUS304) having air inlet ports 61 (2.5 mm×2.5 mm rectangle, the number of openings 128) for air intake and having a 1 mm thickness was disposed on the moisture retention layer 50.

Then, under the environment of a 25° C. temperature and a 50% relative humidity, pure methanol with a 99.9 wt. % purity was supplied to the aforesaid fuel cell 1. A constant voltage power source as an external load was connected, and a current flowing in the fuel cell 1 was controlled so as to gradually increase from “0”. The current was controlled so that a value (current density) of a current flowing in each of the unit membrane electrode assemblies 10 per 1 cm² area increases by 10 mA per minute. For example, the current was controlled so that 15 minutes after the current starts to flow, a 150 mA current flowed in each of the unit membrane electrode assemblies 10 per 1 cm² area. Then, a voltage generated in each of the unit membrane electrode assemblies 10 in accordance with this current control was measured. When an average value of the measured voltages reached 0.2 V (that is, when the voltage generated in the whole membrane electrode assembly group 5 reached 0.8V), the increase in current was finished.

The measurement result of the voltage of each of the unit membrane electrode assemblies 10 in accordance with the current control in the example 1 is shown in FIG. 16.

### Example 2

The structure of a fuel cell used in the example 2 was the same as the structure of the fuel cell 1 used in the example 1 except in that a membrane electrode assembly group including the same structure as that of the membrane electrode assembly group 5 shown in FIG. 3 was used.

As shown in FIG. 3, in the used membrane electrode assembly group 5, each unit membrane electrode assembly 10 was formed in a triangular shape and the unit membrane electrode assemblies 10 were uniformly arranged two-dimensionally around a given center point, whereby the membrane electrode assembly group 5 was formed in a rectangular shape. Further, the membrane electrode assembly group 5 was composed of the unit membrane electrode assemblies 10 having two kinds of triangular shapes, and the unit membrane electrode assemblies 10 were formed so that an area of a surface in the unit membrane electrode assembly 10 with the smallest area became 98.8% of an area of a surface in the unit membrane electrode assembly 10 with the largest area. Further, the total area of surfaces of all the unit membrane electrode assemblies forming the membrane electrode assembly group 5 was 3219.5 mm².

The structure and set values other than those described above were the same as those of the fuel cell 1 used in the example 1. Further, current control, and a measuring method and a measuring condition of voltages of the unit membrane electrode assemblies in accordance with the current control, and so on were the same as those of the example 1.

The measurement result of the voltage of each of the unit membrane electrode assemblies 10 in accordance with the current control in the example 2 is shown in FIG. 16.

### Comparative Example 1

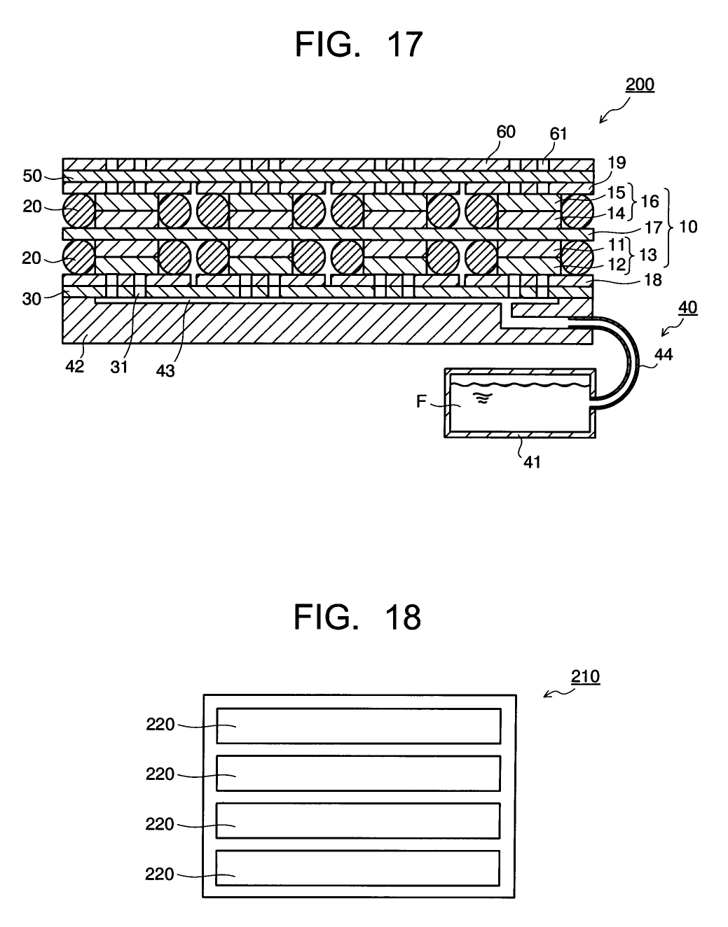

FIG. 17 is a cross-sectional view showing the structure of a fuel cell 200 used in the comparative example 1. FIG. 18 is a plane view when a membrane electrode assembly group 210 in the fuel cell 200 used in the comparative example 1 is seen from above the fuel cell 200 shown in FIG. 17. Portions having the same structures as those of the fuel cell 1 of the embodiment according to the present invention are denoted by the same reference numerals and symbols and redundant description thereof will be simplified.

In the fuel cell 200 used in the comparative example 1, one unit membrane electrode assembly 220 was disposed in each lateral line, whereby the membrane electrode assembly group 210 was formed, as shown in FIG. 17 and FIG. 18. The structure of the fuel cell 200 used in the comparative example 1 was the same as the structure of the fuel cell 1 used in the example 1 except in that the membrane electrode assembly group 210 was formed in this manner.

As shown in FIG. 18, the one rectangular unit membrane electrode assembly 220 was disposed in each lateral line, whereby the membrane electrode assembly group 220 was formed in a rectangular shape. Further, the total area of surfaces of all the unit membrane electrode assemblies forming the membrane electrode assembly group 210 was 3200 mm².

The structure and set values other than those described above were the same as those of the fuel cell 1 used in the example 1. Further, current control, a measuring method and a measuring condition of voltages of the unit membrane electrode assemblies 220 in accordance with the current control, and so on were the same as those of the example 1.

The measurement result of the voltage of each of the unit membrane electrode assemblies 220 in accordance with the current control in the comparative example 1 is shown in FIG. 16.

### Summary of the Example 1, the Example 2, and the Comparative Example 1

As shown in FIG. 16, in the fuel cells used in the example 1 and the example 2, the voltages of the four unit membrane electrode assemblies were almost equal. Since the voltages of the four unit membrane electrode assemblies in the example 1 were almost equal to those of the example 2, the measurement results in the example 1 and the example 2 are shown by one line in FIG. 16.

On the other hand, in the fuel cell used in the comparative example 1, it was found out that the voltages of the two unit membrane electrode assemblies (hereinafter, referred to as outer unit membrane electrode assemblies) disposed on outer sides, that is, disposed on both ends shown in FIG. 18 rapidly lowered when a current value exceeded a predetermined value, but the voltages of the two unit membrane electrode assemblies (hereinafter, referred to as inner unit membrane electrode assemblies) disposed on an inner side, that is, disposed between the outer unit membrane electrode assemblies were kept higher than the voltages in the outer unit membrane electrode assemblies. Since the voltages in the two outer unit membrane electrode assemblies were almost equal and the voltages in the two inner unit membrane electrode assemblies were almost equal, the measurement results of each pair are shown by one line in FIG. 16. Thus, in the fuel cell used in the comparative example 1, a voltage characteristic differs depending on the positions where the unit membrane electrode assemblies are disposed. Further, from the measurement result in the comparative example 1, it is thought that polarity reversal occurred in the outer unit membrane electrode assemblies during the power generation.

From the above results, it has been found out that in the fuel cells used in the example 1 and the example 2 each including the structure of the membrane electrode assembly group according to the present invention, the voltages of the unit membrane electrode assemblies are constantly almost equal, and therefore, a great output can be obtained as the whole membrane electrode assembly group without any occurrence of polarity reversal even when a large current is made to flow.

In the foregoing, various kinds of embodiments are described, but the present invention is not limited to the above-described embodiments, and when carried out, the present invention can be embodied with the constituent elements being modified without departing from the technical idea of the present invention. Further, various modifications are possible such as appropriately combining the plural constituent elements shown in the above-described embodiments, deleting some constituent elements from all the constituent elements shown in the embodiments. The embodiments of the present invention can be expanded or changed within a range of the technical ideas of the present invention, and the expanded and changed embodiments are also included in the technical scope of the present invention.

For example, as for vapor of the liquid fuel supplied to the membrane electrode assemblies, the vapor of the liquid fuel may be supplied to all of them, but the present invention is also applicable to a case where part thereof is supplied with the liquid fuel in a liquid state. Further, the fuel cell of the semi-passive type may be structured such that a fuel shutoff valve is disposed instead of the pump, provided that the fuel is supplied from the fuel storage part to the membrane electrode assemblies. In this case, the fuel shutoff valve is provided in order to control the supply of the liquid fuel via the channel.

Further, the concrete structure, the fuel supply state, and so on of the fuel cell are not limited to specific ones, and for example, the present invention is applicable to various forms such as a type in which a liquid fuel is directly distributed under an anode conductive layer, an external vaporization type in which a liquid fuel is vaporized outside a fuel cell and a vaporized gaseous fuel is distributed under an anode conductive layer, an internal vaporization type in which a liquid fuel is stored in a fuel storage part and the liquid fuel is vaporized inside a cell to be supplied to an anode catalyst layer.

### INDUSTRIAL APPLICABILITY

According to the fuel cell of the embodiments of the present invention, the membrane electrode assembly group can be structured such that the plural unit membrane electrode assemblies are uniformly arranged two-dimensionally so as to be predetermined intervals apart from one another in the circumferential direction around a given center point, with the same electrodes being set on the same side. With this structure, the unit membrane electrode assemblies have the same temperature distribution state, that is, the same temperature uneven state, which can realize a fuel cell having substantially the same output characteristic in the unit membrane electrode assemblies. Further, since substantially the same output characteristic is obtained in the unit membrane electrode assemblies, it is possible to realize a fuel cell capable of preventing polarity reversal that occurs by the unevenness in output among the unit membrane electrode assemblies when the unit membrane electrode assemblies are electrically connected in series. Further, the fuel cell according to the embodiments of the present invention is effectively used as a fuel cell of a liquid fuel direct supply type and the like, for instance.

What is claimed is:

1. A fuel cell, comprising:
a membrane electrode assembly group in which a plurality of unit membrane electrode assemblies having fuel electrodes, air electrodes, and an electrolyte membrane sandwiched by the fuel electrodes and the air electrodes are arranged two-dimensionally so as to be a predetermined interval apart from each other in a circumferential direction around a given center point, with the same electrodes being set on a same side; and
a fuel supply mechanism disposed on the fuel electrode side of the membrane electrode assembly group and supplying a fuel to the fuel electrodes.

2. The fuel cell according to claim 1,
wherein areas of surfaces of the unit membrane electrode assemblies are equal to each other.

3. The fuel cell according to claim 1,
wherein among the plural unit membrane electrode assemblies, an area of a surface in the unit membrane electrode assembly with a smallest surface area is equal to or more than 90% of an area of a surface of the unit membrane electrode assembly with a largest surface area.

4. The fuel cell according to claim 1,
wherein in the membrane electrode assembly group, the unit membrane electrode assemblies are disposed coplanarly in a circular, quadrangular, or polygonal arrangement.

5. The fuel cell according to claim 1, further comprising,
conductive layers corresponding to the fuel electrodes and the air electrodes of the unit membrane electrode assemblies respectively,
wherein the conductive layers are formed from a sheet having conductive sheets and folded along boundaries of the conductive sheets with the membrane electrode assembly group being interposed, the sheet being a sheet in which the conductive sheets are arranged two-dimensionally and with a predetermined structure on one insulating sheet so as to correspond to the fuel electrodes and the air electrodes of the unit membrane electrode assemblies respectively and the conductive layers on the fuel electrode side and the conductive layers on the air electrode side are electrically connected in order for the unit membrane electrode assemblies to be electrically connected in series.

6. The fuel cell according to claim 1, further comprising,
conductive layers corresponding to the fuel electrodes and the air electrodes of the unit membrane electrode assemblies respectively,
wherein the conductive layers are formed from a fuel electrode side sheet and an, air electrode side sheet which are set to face each other via the membrane electrode assembly group, the fuel electrode side sheet having conductive sheets which are arranged two-dimensionally on one insulating sheet so as to correspond to the fuel electrodes of the unit membrane electrode assemblies respectively, and the air electrode side sheet having conductive sheets which are arranged two-dimensionally on one insulating sheet so as to correspond to the air electrodes of the unit membrane electrode assemblies respectively, and the conductive layers on the fuel electrode side and the conductive layers on the air electrode side being electrically connected in order for the unit membrane electrode assemblies to be electrically connected in series.

7. The fuel cell according to claim 1, further comprising:
conductive layers provided so as to correspond to the fuel electrodes and the air electrodes of the unit membrane electrode assemblies;
an outer case covering the membrane electrode assembly group including the conductive layers; and
a fastening bolt passing through centers of the outer case and a stack composed of the membrane electrode assembly group including the conductive layers.

8. The fuel cell according to claim 1, further comprising,
an insulating member electrically insulating the adjacent unit membrane electrode assemblies from each other.
